(19) United States
(12) Patent Application Publication
(10) Pub. No.: US 2005/0236902 A1
(43) Pub. Date: Oct. 27, 2005

(54) Portable device for automotive device control system

(75) Inventors: Nobuyoshi Nagai, Kariya-city (JP); Mitsugi Ohtsuka, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/110,825

(22) Filed: Apr. 21, 2005

(30) Foreign Application Priority Data
Apr. 23, 2004 (JP) 2004-127930

(51) Int. Cl. H02J 7/06

(52) U.S. Cl. 307/100

(57) ABSTRACT

A portable device for receiving and sending a signal to an automotive device control system includes a communication means for receiving and sending the signal to the automotive device control system, a control means for controlling the communication means, a potential detection means for detecting electrical potential of a battery used to energize the communication means and the control means, and a detection control means for controlling detection operation of the potential detection means. The detection control means operates the potential detection means either in a continuous monitor mode or in an intermittent monitor mode in order to detect potential of the battery. The intermittent monitor mode is used when potential of the battery is equal to or higher than a predetermined potential, and the continuous monitor mode is used when potential of the battery is lower than a predetermined potential.

### CROSS REFERENCE TO RELATED APPLICATION

This application is based on and claims the benefit of priority of Japanese Patent Application No. 2004-127930 filed on Apr. 23, 2004, the disclosure of which is incorporated herein by reference.

### FIELD OF THE INVENTION

The present invention relates to a portable device for an automotive device control system and, more specifically, to a portable device for controlling access to automobile and automotive devices based on communication between the portable device and the automotive device control system.

### BACKGROUND OF THE INVENTION

In recent years, remote access control systems for automobile such as SMARTKEY SYSTEM (registered trademark) is known and used for controlling access to an automotive device control system. This type of system controls access to an automobile by locking and unlocking doors, starting an engine, unlocking a steering wheel and opening a trunk lid through a radio communication between a portable device carried by a user and a main part of the system disposed in an automobile.

The portable device generally uses a battery for electrical power supply. Therefore, portable device continuously monitors voltage potential of the battery by using a voltage monitor circuit and initializes its internal setting in order to prevent malfunction of the portable device because of a low voltage potential. An operation scheme described above for a conventional portable device is disclosed in Japanese Patent Document JP-A-2002-247656.

However, the operation scheme for the conventional portable device suffers from decreased battery life because the conventional portable device continuously consumes electricity of the battery to operate the voltage monitor circuit.

### SUMMARY OF THE INVENTION

In view of the above-described problems, it is an object of the present invention to provide a portable device for an automotive device control system that has an extended battery life by reducing electricity consumption.

The portable device for the automotive device control system of the present invention includes a communication means for sending and receiving a signal from a main body of the automotive device control system, a control means for controlling the communication means, a potential detection means for detecting electrical potential of a battery used to energize the communication means and the control means, and a detection control means for controlling operation of the potential detection means. Operation mode of the potential detection means is chosen from a continuous monitor mode and an intermittent monitor mode, based on a detected electrical potential of the battery. The detection control means chooses the intermittent monitor mode when the electrical potential of the battery is equal to or higher than a predetermined electrical potential, and it chooses the continuous monitor mode when the battery potential is lower than the predetermined electrical potential.

The potential detection means operated in the above described manner consumes less electricity of the battery in the intermittent monitor mode than in the continuous monitor mode for the operation of the potential detection means because the potential detection means uses electrical power intermittently in the intermittent monitor mode while the battery potential is higher than the predetermined electrical potential. Therefore, electricity consumption for detecting electrical potential decreases and the battery of the portable device has an extended life.

The potential detection means operates in the continuous monitor mode when the electrical potential of the battery is lower than the predetermined electrical potential. In this manner, the portable device can prevent malfunction caused by an insufficient electrical potential.

The detection control means puts the portable device in a sleep state that stops monitoring of a battery potential while the portable device is waiting for a transmission signal from the main body of the automotive device control system in the intermittent monitor mode. The detection control means switches to a resume state for detecting the battery potential when the portable device has received the transmission signal from the main body of the automotive control system. The detection control means returns to the sleep state when the portable device has sent a response signal to the transmission signal.

The detection control means detects battery potential of the portable device after sending the response signal to the main body of the automotive device control system when potential detection means operates in the intermittent monitor mode. This is because sending the response signal consumes electrical power of the battery and lowers the battery potential. In this manner, the battery potential is detected appropriately in the intermittent monitor mode.

### BRIEF DESCRIPTION OF THE DRAWINGS

Other objects, features and advantages of the present invention will become more apparent from the following detailed description made with reference to the accompanying drawings, in which:

FIG. 1 is a block diagram of a portable device and a main body of an automotive device control system according to an embodiment of the present invention;

FIG. 2 is a flowchart of a battery potential detection method used in the portable device; and

FIG. 3 is a time chart that illustrates the battery potential detection method in relation to a series of changes in the battery potential.

### DETAILED DESCRIPTION OF THE PREFERRED EMBODIMENTS

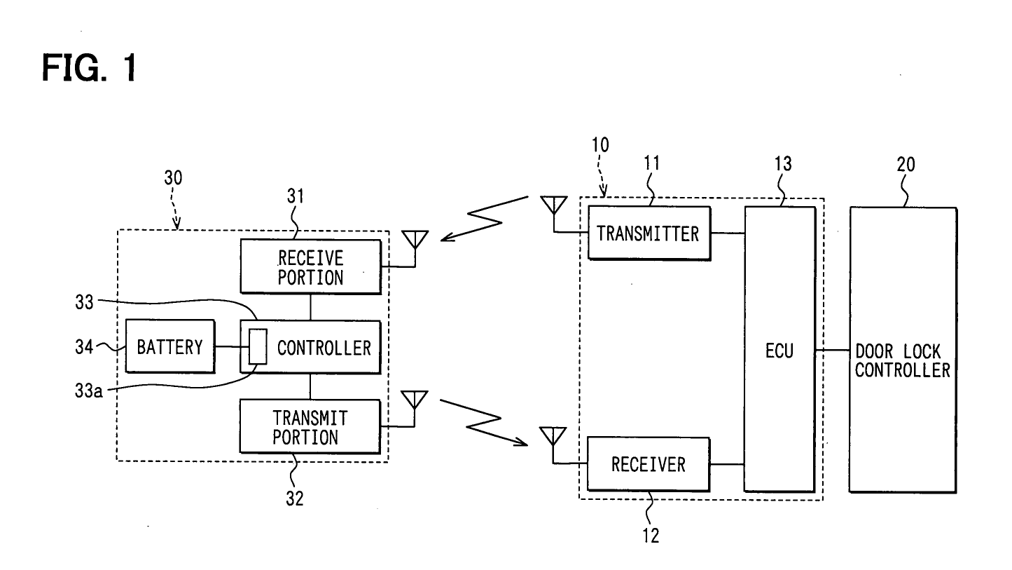

An embodiment of the present invention is described with reference to FIGS. 1 to 3.

FIG. 1 shows a block diagram of an automotive device control system having a portable device. The automotive device control system includes an automotive device control apparatus 10 installed on an automobile, a door lock controller 20 and a portable device 30. The automotive device control apparatus 10 and the portable device 30 communicates with each other.

The automotive device control apparatus 10 includes a transmitter 11, a receiver 12, and a control ECU 13. The transmitter 11 and the receiver 12 are disposed in a compartment of the automobile or on the outside of the compartment. For example, the transmitter 11 and the receiver 12 are disposed in a part close to a door handle. The transmitter 11 transmits a transmission signal to the outside of the compartment upon receiving a transmission control signal from the control ECU 13. The receiver 12 receives an ID code signal from the portable device 30 and outputs the ID code signal to the control ECU 13.

The control ECU 13 is installed on the automobile and controls the transmitter 11 and the receiver 12. The control ECU 13 has a memory for storing a transmitter control program, an ID code of the portable device 30 and the like. The control ECU 13 compares the ID code transmitted from the portable device 30 with the ID code stored in the memory, and determines if those two codes are the same. The control ECU 13 re-transmits a transmission signal based on the comparison result and outputs an operation signal to the door lock controller 20. The door lock controller 20 locks or unlocks doors upon receiving the operation signal from the control ECU 13.

The portable device 30 includes a receive portion 31, a transmit portion 32, a controller 33, and a battery 34. The receive portion 31, the transmit portion 32 and the controller 33 in this embodiment are implemented as an IC chip respectively. The receive portion 31 receives the transmission signal from the transmitter 11 of the automobile device control apparatus 10 and the transmit portion 32 transmits a signal back to the receiver 12 of the automobile device control apparatus 10. The controller 33 is implemented as a microcomputer of well-known type including a CPU, a memory and the like. The portable device 30 has its own ID code and the ID code is stored in the memory of the controller 33. The controller 33 is programmed to transmit an ID code signal including the ID code to the receiver 12 on the apparatus 10 through the transmit portion 32 when it receives the transmission signal from the transmitter 11 of the apparatus 10 through the receive portion 31.

The battery 34 supplies electricity to the receive portion 31, the transmit portion 32 and the controller 33. The controller 33 has an electrical potential monitor circuit 33a to detect an electrical potential of the battery 34. In this embodiment, a source potential Vdd of the battery 34 is specified as 3 volt, and a reset potential Vret is specified as 1.8 volt. The reset potential is used as a threshold for initializing the portable device 30 in order to avoid malfunction of the portable device 30.

The portable device 30 monitors the potential of the battery 34 in an intermittent monitor mode or in a continuous monitor mode. The intermittent monitor mode is further defined as an alternating operation of a sleep state and a resume state, that is, the sleep state for stopping operation of potential detection and the resume state for resuming operation of potential detection. The continuous monitor mode continuously monitors the electrical potential of the battery 34. The two modes of potential detection are switched based on a switch potential Vdet. In this embodiment, the switch potential Vdet is determined as a higher potential, i.e., 1.9 volt, than the reset potential Vret.

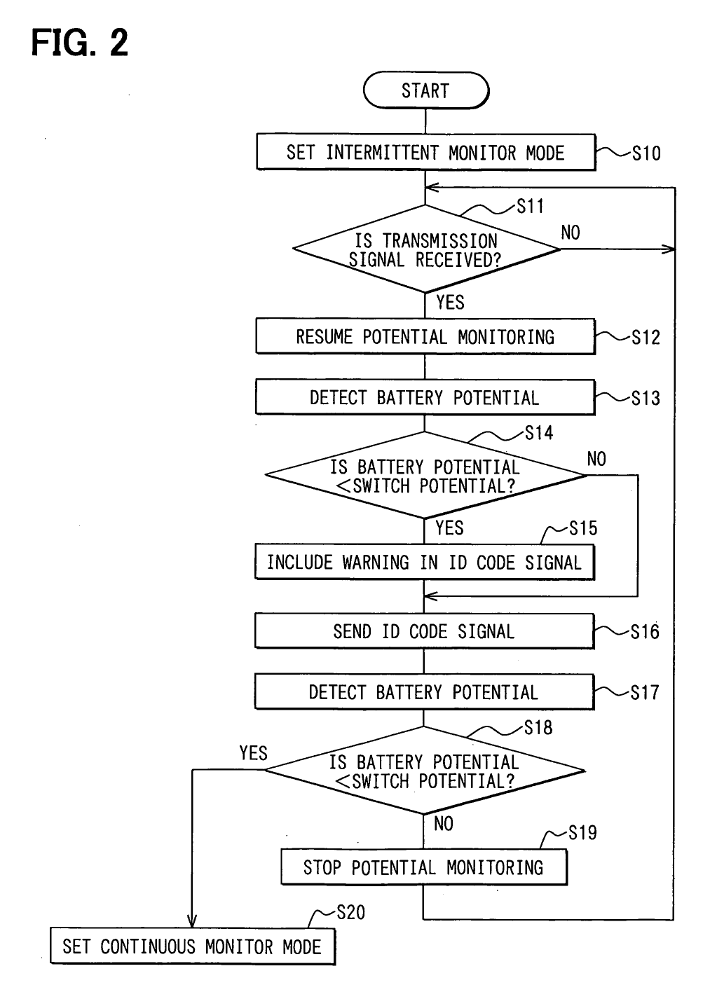

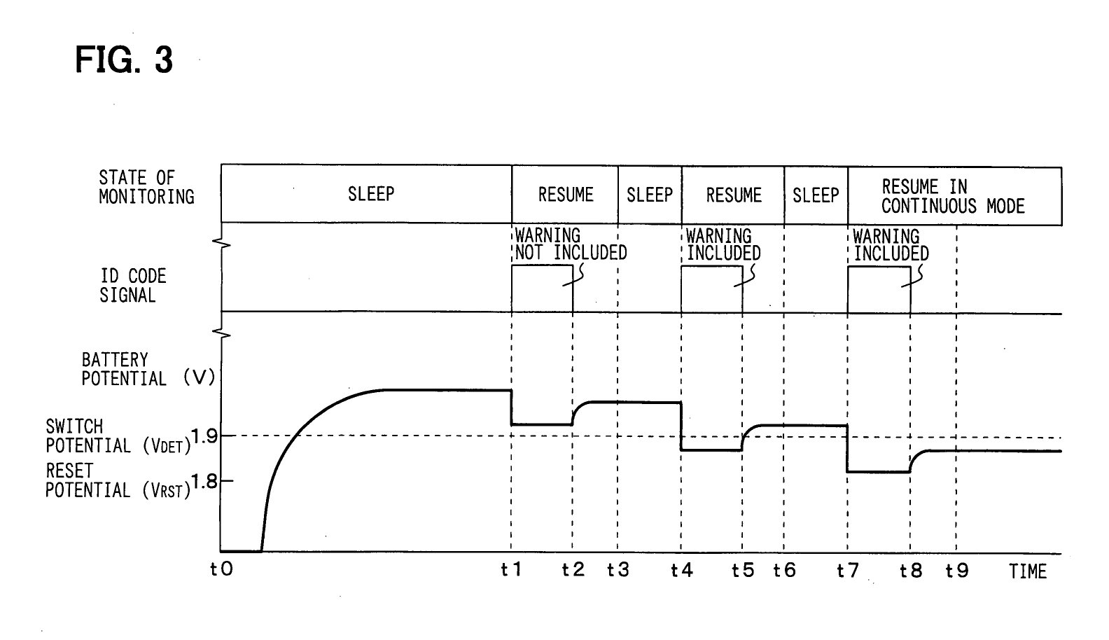

Potential monitor operation of the portable device 30 is described with reference to FIGS. 2 and 3.

FIG. 2 shows a flowchart of potential monitor operation controlled by the controller 33 based on a program stored therein. The operation starts with step S10 where the potential monitor mode is set to the intermittent monitor mode. In the intermittent monitor mode, an initial state of monitoring is the sleep state that stops potential detection of the battery 34. Then, the portable device 30 waits for a reception of the transmission signal transmitted from the transmitter 11 of the apparatus 10 on the automobile (step S11). The state of monitor operation is changed to the resume state upon receiving (step S11: yes) the transmission signal (step S12) and the potential detection circuit 33a detects the potential of the battery 34 (step S13). Step 11 repeats itself (step S11: no) until the transmission signal is received.

The detected potential is compared with the switch potential Vdet in step S14. When the detected potential is lower than the switch potential Vdet (step S14: yes), the ID code signal including low potential warning (step S15) is transmitted to the receiver 12 on the automobile (step S16). When the detected potential is not lower than the switch potential Vdet (step S14: no), the ID code signal transmitted to the receiver 12 does not include low potential warning (step S15 skipped).

The potential of battery 34 is detected again by the potential detection circuit 33a after the ID code signal is transmitted to the receiver 12 (step S17). The detected potential is compared with the switch potential Vdet (step S18). When the detected potential is equal to or higher than the switch potential Vdet (step S18: no), the resume state of the intermittent monitor mode is switched to the sleep state (step S19). When the detected potential is lower than the switch potential Vdet (step S18: yes), the intermittent monitor mode is switched to the continuous monitor mode (step S20).

FIG. 3 shows a time chart that illustrates battery potential detection method in relation to a series of changes in the potential of the battery 34 along the time parameter t. The initial state of the monitor operation is the sleep state as shown in FIG. 3.

The potential of the battery 34 lowers because of the ID code signal transmission operation after the portable device 30 receives the transmission signal from the transmitter 11 of the apparatus 10 on the automobile (time t1). The potential of the battery 34 is detected upon receiving the transmission signal. The monitor operation is switched from the sleep state to the resume state according to the program. The ID code signal does not include low potential warning at this point, because the potential is not lower than the switch potential Vdet.

The potential of the battery 34 gradually regains after transmission of the ID code signal (time t2). The potential of the battery 34 is detected just before the monitor operation is switched from the resume state to the sleep state (time t3). The monitor operation is switched from the resume state to the sleep state because the detected potential is not lower than the switch potential Vdet at time t3.

Next, the potential of the battery 34 is detected upon receiving the transmission signal from the transmitter 11. The monitor operation is switched from the sleep state to the resume state according to the program (time t4). The ID code signal includes low potential warning, because the potential is lower than the switch potential Vdet at time t4.

The ID code transmission ends at time t5. The potential of the battery 34 is detected just before the monitor operation is switched from the resume state to the sleep state (time t6). The monitor operation is switched from the resume state to the sleep state because the detected potential is not lower than the switch potential Vdet at time t6.

Next, the potential of the battery 34 is detected upon receiving the transmission signal from the transmitter 11. The monitor operation is switched from the sleep state to the resume state according to the program (time t7). The ID code signal includes low potential warning, because the potential is lower than the switch potential Vdet at time t7.

The ID code transmission ends at time t8. The potential of the battery 34 is detected just before the monitor operation is switched from the resume state to the sleep state (time t9). The monitor operation is changed from the intermittent monitor mode to the continuous monitor mode because the detected potential is lower than the switch potential Vdet at time t9.

The above-described scheme of the potential detection saves battery energy used by potential detection because operation of the detection circuit stops intermittently in the intermittent monitor mode while the detected potential of the battery 34 is equal to or higher than the switch potential Vdet. Therefore, the battery life of the portable device 30 is extended.

The monitor operation is changed from the intermittent monitor mode to the continuous monitor mode when the detected potential of the battery 34 is lower than the switch potential Vdet. The change of the monitor modes serves as a preparation for further decrease of the battery potential. In this manner, malfunction of the portable device 30 can be prevented because detection circuit is operated continuously for potential detection.

The battery potential of the portable device decreases when it transmits the ID code signal to the automotive device control apparatus 10. Therefore, the battery potential is preferably monitored when the ID code signal is transmitted.

Although the present invention has been fully described in connection with the preferred embodiment thereof with reference to the accompanying drawings, it is to be noted that various changes and modifications will become apparent to those skilled in the art.

For example, though the present invention is applied to the portable device 30 of the automotive device control system, the invention can also be applied to a portable device for two-way communication between a system and a portable device that requires extended battery life for continuous operation.

Such changes and modifications are to be understood as being within the scope of the present invention as defined by the appended claims.

1. A portable device of an automotive device control system for controlling access to an automobile based on a communication to the automotive device control system comprising:
a communication means for receiving and sending a signal to the automotive device control system;
a control means for controlling the communication means;
a potential detection means for detecting electrical potential of a battery used to energize the communication means and the control means and
a detection control means for controlling detection operation of the potential detection means,
wherein the detection control means operates the potential detection means either continuously in a continuous monitor mode or intermittently in an intermittent monitor mode in order to detect electrical potential of the battery,
wherein the detection control means operates the potential detection means in the intermittent monitor mode when electrical potential of the battery is equal to or higher than a predetermined switch potential, and
wherein the detection control means operates the potential detection means in the continuous monitor mode when electrical potential of the battery is lower than the predetermined switch potential.

2. The portable device of claim 1,
wherein the potential detection means in the intermittent monitor mode operates either in a sleep state that stops detection operation or in a resume state that resumes detection operation,
wherein detection operation of the potential detection means starts with the sleep state,
wherein the detection control means keeps the potential detection means in the sleep state until the communication means receives the signal from the automotive device control system,
wherein the detection control means puts the potential detection means in the resume state when the portable device has received the signal from the automotive device control system,
wherein the detection control means puts the potential detection means in the sleep state after the communication means has sent a response signal in response to the signal from the automotive device control system.

3. The portable device of claim 2,
wherein the detection control means uses the potential detection means to detect electrical potential of the battery at a predetermined period of time after the communication means has sent the response signal to the automotive device control system.

4. The portable device of claim 3,
wherein the detection control means switches operation of the potential detection means to the continuous monitor mode when detected electrical potential of the battery is lower than the predetermined switch potential.

5. The portable device of claim 1,
wherein the detection control means initializes the portable device when detected electrical potential of the battery is lower than a predetermined potential for initialization.
